(19) United States
(12) Patent Application Publication
(10) Pub. No.: US 2015/0249546 A1
(43) Pub. Date: Sep. 3, 2015

(54) COMBINED TRANSMISSION OF MULTIPLE-PRIORITY NETWORK TRAFFIC

(71) Applicants: Xiangyang ZHENG, (US); Patrick K.M. TSE, (US); Yue CAO, (US); Yuan LI, (US); QUALCOMM INCORPORATED, San Diego, CA (US)

(72) Inventors: Xiangyang Zheng, Shanghai (CN); Patrick Tse, Toronto (CA); Yue Cao, Shanghai (CN); Yuan Li, Shanghai (CN)

(21) Appl. No.: 14/430,195

(22) PCT Filed: Oct. 29, 2012
(86) PCT No.: PCT/CN2012/083665

§ 371 Date: Mar. 20, 2015

(51) Int. Cl. H04L 12/403; H04J 3/16

(52) U.S. Cl. CPC H04L 12/4035; H04J 3/1694

(57) ABSTRACT

A method of transmitting data includes storing high-priority data blocks in a high-priority queue, storing low-priority data blocks in a low-priority queue, and generating a first data unit that includes one or more of the high-priority data blocks and one or more of the low-priority data blocks. Generating the first data unit includes arranging the one or more high-priority data blocks and the one or more low-priority data blocks in a sequence in which the one or more high-priority data blocks precede the one or more low-priority data blocks. Generating the first data unit further includes indexing the one or more high-priority data blocks and the one or more low-priority data blocks in accordance with the sequence. The first data unit is transmitted.

### TECHNICAL FIELD

The present embodiments relate generally to communication systems, and specifically to networks that have multiple-priority traffic.

### BACKGROUND OF RELATED ART

Data to be transmitted by a networked device may be divided into multiple data blocks (e.g., PHY blocks of a fixed length), which are then combined into data units (e.g., MAC protocol data units or MPDUs). Data transmission efficiency increases as more data, and thus more data blocks, are included in a single data unit. However, the data blocks may have different priorities. Combining data blocks of different priorities into a single data unit presents challenges.

### BRIEF DESCRIPTION OF THE DRAWINGS

The present embodiments are illustrated by way of example and are not intended to be limited by the figures of the accompanying drawings.

FIG. 1 is a block diagram of a system with coax links in accordance with some embodiments.

FIG. 2A illustrates a sequence of beacon periods in accordance with some embodiments.

FIG. 2B illustrates time slots in a beacon period in accordance with some embodiments.

FIG. 3 is a block diagram of a master device coupled to a plurality of slave devices in accordance with some embodiments.

FIG. 4 is a block diagram illustrating an MPDU in accordance with some embodiments.

FIGS. 5A-5C illustrate MPDU generation in accordance with some embodiments.

FIG. 6 is a time line illustrating transmission of MPDUs and corresponding acknowledgments in accordance with some embodiments.

FIGS. 7A and 7B are flow charts illustrating a method of transmitting data in accordance with some embodiments.

FIG. 8A is a block diagram of a master device in accordance with some embodiments.

FIG. 8B is a block diagram of a slave device in accordance with some embodiments.

Like reference numerals refer to corresponding parts throughout the drawings and specification.

### DETAILED DESCRIPTION

Embodiments are disclosed in which data blocks of different priorities and data blocks that are to be retransmitted are combined into a single data unit for transmission.

In some embodiments, a method of transmitting data includes storing high-priority data blocks in a high-priority queue, storing low-priority data blocks in a low-priority queue, and generating a first data unit that includes one or more of the high-priority data blocks and one or more of the low-priority data blocks. Generating the first data unit includes arranging the one or more high-priority data blocks and the one or more low-priority data blocks in a sequence in which the one or more high-priority data blocks precede the one or more low-priority data blocks. Generating the first data unit further includes indexing the one or more high-priority data blocks and the one or more low-priority data blocks in accordance with the sequence. The first data unit is transmitted.

In some embodiments, an electronic device includes a high-priority queue to store high-priority data blocks, a low-priority queue to store low-priority data blocks, and a media access controller (MAC) to generate a first data unit comprising one or more of the high-priority data blocks arranged in a sequence with one or more of the low-priority data blocks. The one or more high-priority data blocks precede the one or more low-priority data blocks in the sequence. The MAC is to index the one or more high-priority data blocks and the one or more low-priority data blocks in accordance with the sequence. The electronic device also includes a transmitter to transmit the first data unit.

In some embodiments, a computer-readable storage medium stores one or more programs configured to be executed by an electronic device comprising one or more processors. The one or more programs include instructions to store high-priority data blocks in a high-priority queue, instructions to store low-priority data blocks in a low-priority queue, and instructions to generate a first data unit that includes one or more of the high-priority data blocks and one or more of the low-priority data blocks. The instructions to generate the first data unit include instructions to arrange the one or more high-priority data blocks and the one or more low-priority data blocks in a sequence, wherein the one or more high-priority data blocks precede the one or more low-priority data blocks in the sequence, and instructions to index the one or more high-priority data blocks and the one or more low-priority data blocks in accordance with the sequence.

In some embodiments, a system includes a plurality of networked electronic devices, including a first electronic device and a second electronic device. The first electronic device includes a high-priority queue to store high-priority data blocks, a low-priority queue to store low-priority data blocks, a retransmission queue to store previously transmitted data blocks that were not correctly received by the second electronic device, and a media access controller (MAC) to generate a first data unit. The first data unit includes a sequence of the previously transmitted data blocks, one or more of the high-priority data blocks, and one or more of the low-priority data blocks. The previously transmitted data blocks precede the one or more high-priority data blocks in the sequence and the one or more high-priority data blocks precede the one or more low-priority data blocks in the sequence. The MAC is to index the one or more high-priority data blocks and the one or more low-priority data blocks in accordance with the sequence. The first electronic device also includes a transmitter to transmit the first data unit. The second electronic device includes a receiver to receive the first data unit and a transmitter to transmit an acknowledgment identifying which data blocks of the first data unit were not correctly received.

In the following description, numerous specific details are set forth such as examples of specific components, circuits, and processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The term “coupled” as used herein means connected directly to or connected through one or more intervening components or circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

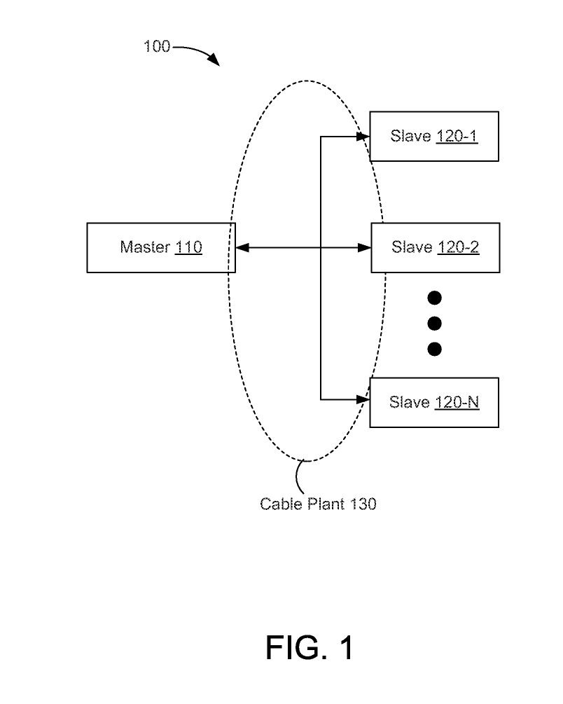

FIG. 1 illustrates a system (e.g., an access network) 100 in which a master device 110 is coupled to multiple slave devices 120-1 through 120-N, where N is an integer greater than one, in accordance with some embodiments. In some embodiments, the master device 110 is coupled to the slave devices 120-1 through 120-N using coaxial cable (“coax”) links that compose a cable plant 130. For example, the system 100 may be an Ethernet over Coax (EoC) access network. In some embodiments, the system 100 may be implemented in accordance with the HomePlug AV/IEEE1901 standard (e.g., as adapted for use with a coax medium). Transmissions from the master device 110 to the slave devices 120-1 through 120-N are referred to as downstream traffic and transmissions from respective slave devices 120-1 through 120-N to the master device 110 are referred to as upstream traffic.

Access to the medium (e.g., the coax links of the cable plant 130) that couples that devices 110 and 120-1 through 120-N is time-multiplexed using a Time-Division Multiple Access (TDMA) protocol. In some embodiments, the master device 110 periodically broadcasts a medium access schedule (also referred to as a channel access schedule) to all slave devices 120-1 through 120-N. For example, the channel access schedule is periodically broadcast in a message called a beacon message or simply a beacon. The channel access schedule assigns dedicated time slots to respective slave devices 120, such that a respective slave device 120 may transmit during its dedicated time slot and not during time slots assigned to other slave devices 120. A scheduler in the master device 110 determines the amount of medium access for each slave device 120, based for example on the service level agreements (SLAs) between end users associated with respective slave devices 120 and the service provider (e.g., cable operator) who controls the master device 110. The scheduler constructs the channel access schedule based on the determined amounts of medium access for the slave devices 120.

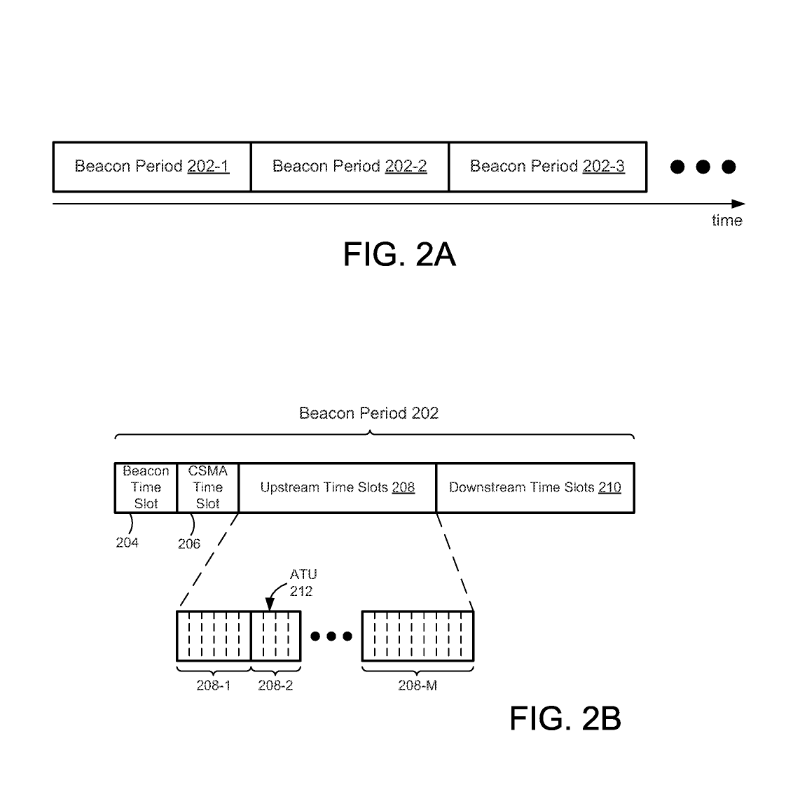

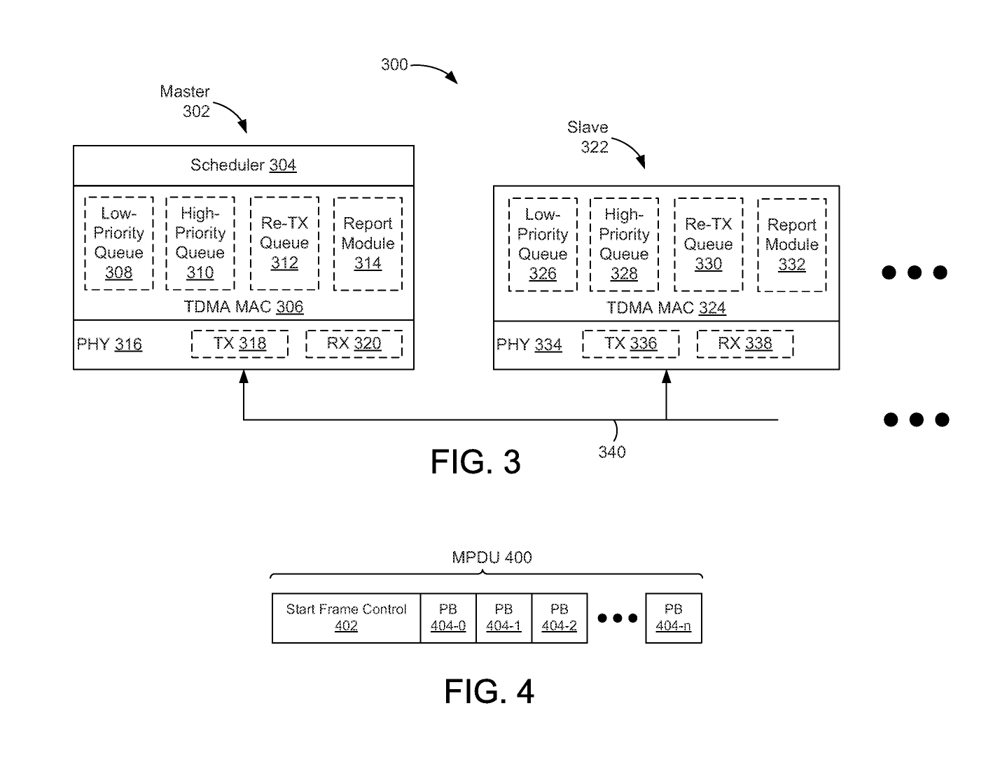

The period between broadcasts of successive channel access schedules (e.g., the period from the beginning of a beacon message to the beginning of the next beacon message) is called a beacon period. FIG. 2A illustrates a sequence of beacon periods in accordance with some embodiments: a first beacon period 202-1 is followed by a second beacon period 202-2, which is followed in turn by a third beacon period 202-3. Each beacon period 202 is divided into different time slots, as shown in FIG. 2B in accordance with some embodiments. A first time slot 204 is allocated for transmission of the beacon message and thus for transmission of the channel access schedule. A second time slot 206 is a contention-based time slot in which the slave devices 120-1 through 120-N may compete for transmission bandwidth in accordance with a carrier-sense multiple access (CSMA) protocol. For example, newly activated slave devices 120 may compete to use the contention-based time slot 206 to register with the master device 110. In some embodiments, the contention-based time slot 206 is not included in every beacon period 202, but instead is only included in a portion of the beacon periods 202.

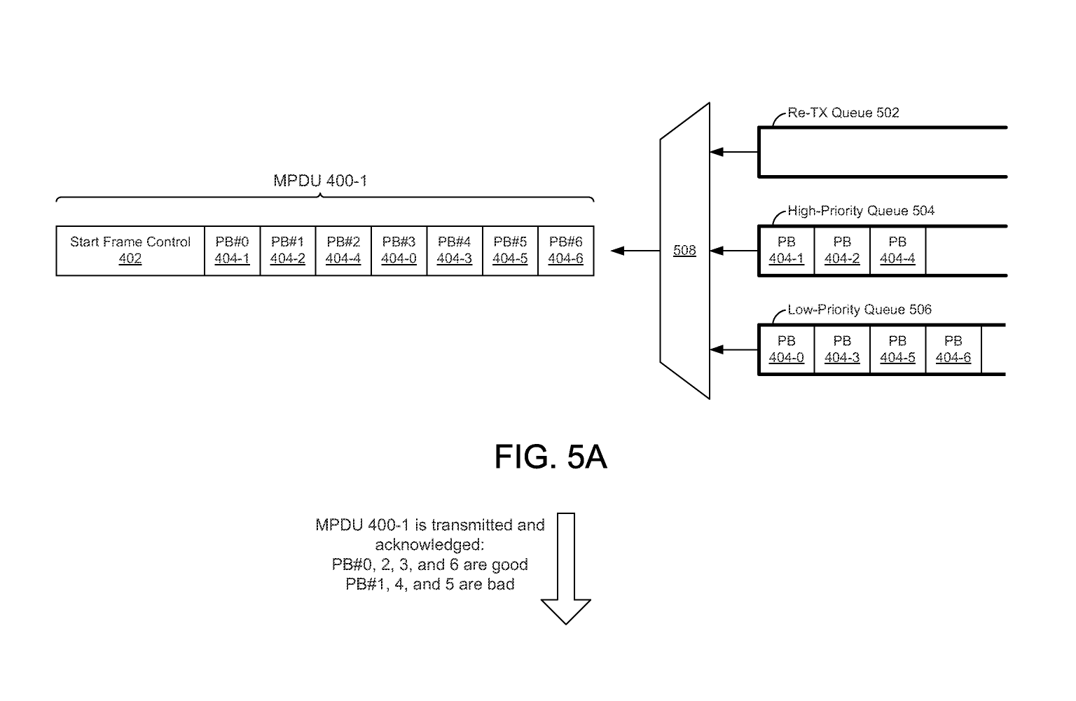

Each beacon period 202 further includes upstream time slots 208 and downstream time slots 210. The time slots 208 and 210 are allocated in accordance with a time-division multiple access (TDMA) protocol. Respective upstream time slots 208 are assigned to respective slave devices 120 for upstream transmissions to the master device 110. These assignments are based at least in part on the reported status of transmission queues in the slave devices 120. For example, a slave device 120 may have multiple queues (e.g., low-priority queue 326, high-priority queue 328, and retransmission queue 330, FIG. 3), each of which buffers upstream traffic (e.g., low priority traffic, high priority traffic, and retransmission traffic, respectively). When an upstream time slot 208 is assigned to a specific slave device 120, traffic buffered in one or more queues of that slave device 120 may be transmitted upstream to the master device 110 during the upstream time slot 208. A first upstream time slot 208-1 thus may be assigned to a first slave device 120-1, a second upstream time slot 208-2 may be assigned to a second slave device 120-2, and so on. A slave device 120 may use an assigned upstream time slot 208 to transmit traffic from multiple queues. For example, each queue may store data blocks. Data blocks from multiple queues may be combined into a single data unit that is transmitted during an upstream time slot 208. In some embodiments, the data blocks are fixed-length blocks. For example, the data blocks are fixed-length physical layer blocks (PHY blocks, referred to as PBs) of 512 bytes each (e.g., as defined in the HomePlug AV/IEEE1901 standard) and the data unit is a media access controller (MAC) protocol data unit (MPDU) (e.g., as defined in the HomePlug AV/IEEE1901 standard).

A total of M upstream time slots 208 are assigned to M slave devices 120, where M is the number of slave devices 120 allowed to transmit during a respective beacon period 202. The number M may vary from beacon period 202 to beacon period 202, depending for example on the available bandwidth and demand for bandwidth during different beacon periods 202.

Downstream time slots 210 are allocated for downstream transmissions by the master device 110. The downstream time slots 210 may include time slots for unicast transmissions to specific slave devices 120 as well as a time slot for broadcasts to all of the slave devices 120-1 through 120-N. Because the downstream time slots 210 are allocated to the master device 110, the slave devices 120 do not transmit during the downstream time slots 210. The master device 110 may have multiple queues (e.g., low-priority queue 308, high-priority queue 310, and retransmission queue 312, FIG. 3), each of which buffers downstream traffic (e.g., low priority traffic, high priority traffic, and retransmission traffic, respectively). The master device 110 may use a downstream time slot 210 to transmit traffic from multiple queues, in the same manner described for upstream transmissions by slave devices 120.

In some embodiments, the lengths (i.e., durations) of the time slots 204, 206, 208, and/or 210 are variable, as shown for the time slots 208-1, 208-2, and 208-M in FIG. 2B. For example, the scheduler in the master device 110 assigns time slots of different lengths to different slave devices 120, in accordance with a dynamic bandwidth allocation (DBA) algorithm. The time slots 204, 206, 208, and 210 are divided into fixed-length allocation time units (ATUs) 212, such that each time slot is an integer number of ATUs 212. An ATU 212 is thus the unit of time for specifying the length of a time slot. In some embodiments (e.g., in accordance with the HomePlug AV/IEEE 1901 standard), an ATU 212 is 10.24 us. The beacon message specifies the length of each time slot by specifying the number of ATUs 212 assigned to each time slot. For example, respective fields in the beacon message contain bits specifying the number of ATUs 212 for respective time slots. The bits specifying the number of ATUs 212 for a respective time slot may be spread over more than one field in the beacon message (e.g., may be divided between two fields). Also, a respective field may include a first set of bits for a first time slot and a second set of bits for a second time slot.

In each beacon period 202 (e.g., during respective upstream time slots 208), the slave devices 120-1 through 120-N report their amounts of queued upstream traffic to the master device 110 so that the master device 110 can create an appropriate channel access schedule for a subsequent (e.g., the next) beacon period 202. The amount of queued upstream traffic for a respective slave device 120 may include the amount of low-priority traffic, high-priority traffic, and/or retransmission traffic queued in the slave device 120 for upstream transmission. The channel access schedule for the subsequent (e.g., next) beacon period 202 assigns upstream time slots 208 based on the reported amounts of queued upstream traffic. (The channel access schedule may also reflect the levels of service provided for in the service level agreements.) Similarly, the channel access schedule assigns downstream time slots 210 based on the amounts of queued downstream traffic in the master device 110.

FIG. 3 illustrates a system 300 that is an example of the system 100 (FIG. 1) in accordance with some embodiments. A master device 302 (e.g., master device 110, FIG. 1) is coupled to slave devices 322 (e.g., slave devices 120, FIG. 1) by a coax link 340. The master device 302 includes a physical layer device (PHY) 316 (e.g., a HomePlug AV PHY) with a transmitter 318 to transmit signals (e.g., orthogonal frequency-division multiplexing (OFDM) signals) over the coax link 340 and a receiver 320 to receive signals (e.g., OFDM signals) from the coax link 340. The master device 302 also includes a TDMA media access controller (MAC) 306 coupled to the PHY 316, and a scheduler 304 (e.g., a DBA scheduler) coupled to the TDMA MAC 306. The slave device 322 includes a PHY 334 (e.g., a HomePlug AV PHY) with a transmitter 336 to transmit signals (e.g., OFDM signals) over the coax link 340 and a receiver 338 to receive signals (e.g., OFDM signals) from the coax link 340. The slave device 322 also includes a TDMA MAC 324 coupled to the PHY 334.

The TDMA MAC 324 of the slave device 322 includes a low-priority queue 326 to store low-priority traffic (e.g., low-priority PBs) and a high-priority queue 328 to store high-priority traffic (e.g., high-priority PBs) for subsequent upstream transmission to the master device 302. The terms low-priority and high-priority as used herein are used with respect to each other: low-priority traffic has lower priority than high-priority traffic, and vice versa. In some embodiments, high-priority traffic includes Voice-over-Internet-Protocol (VoIP) traffic. The TDMA MAC 324 also includes a retransmission (re-TX) queue 330 to store traffic (e.g., PBs) that was previously transmitted but was reported as not having been received correctly. For example, when the slave device 322 transmits to the master device 302 an MPDU that includes multiples PBs, the master device 302 responds with a selective acknowledgment (SACK) that identifies which of the PBs were correctly received and/or which of the PBs were not correctly received. The slave device 322 stores the PBs that were not correctly received in the retransmission queue 330 for subsequent retransmission to the master device 302. The TDMA MAC 324 further includes a report module 332 that monitors the status (e.g., the lengths, and thus the amount of queued traffic) of the queues 326, 328, and 330 and prepares reports for transmission to the master device 302 that report the status of the queues 326, 328, and 330. The slave device 322 transmits these reports to the master device 302 during upstream time slots 208 (FIG. 2B). The report module 332 also prepares acknowledgments (e.g., SACK messages) that identify PBs that are correctly and/or incorrectly received from the master device 302. Whether a respective PB has been correctly received is determined, for example, based on a checksum.

The TDMA MAC 306 of the master device 302 includes a low-priority queue 308 to store low-priority downstream traffic (e.g., low-priority PBs) for subsequent transmission, a high-priority queue 310 to store high-priority downstream traffic (e.g., high-priority PBs) for subsequent transmission, and a retransmission (re-TX) queue 312 to store downstream traffic (e.g., PBs) that was previously transmitted to the slave device 322 but was not correctly received (e.g., as indicated by a SACK message from the slave device 322) and thus is to be retransmitted. In some embodiments, the TDMA MAC 306 includes a separate low-priority queue 308, high-priority queue 310, and retransmission queue 312 for each slave device 322 to which the master device 302 is coupled. The TDMA MAC 306 also includes a report module 314 to prepare acknowledgments (e.g., SACK messages) that identify PBs that are correctly and/or incorrectly received from the slave device 322.

In some embodiments, the TDMA MACs 306 and 324 convert variable-length frames (e.g., Ethernet frames) into fixed-length data blocks (e.g., PBs) that are stored in the queues (e.g., in respective low-priority queues 308 and 326 and respective high-priority queues 310 and 328) prior to transmission. The variable-length frames may include low-priority frames and high-priority frames, and data blocks created from a frame have the same priority as the frame. The fixed-length PBs stored in the queues are then combined into data units (e.g., MPDUs) for transmission. A respective data unit may include one or more data blocks, and the number of data blocks may vary from data unit to data unit. In the receive direction, data blocks are extracted from received data units and used to create variable-length frames (e.g., Ethernet frames).

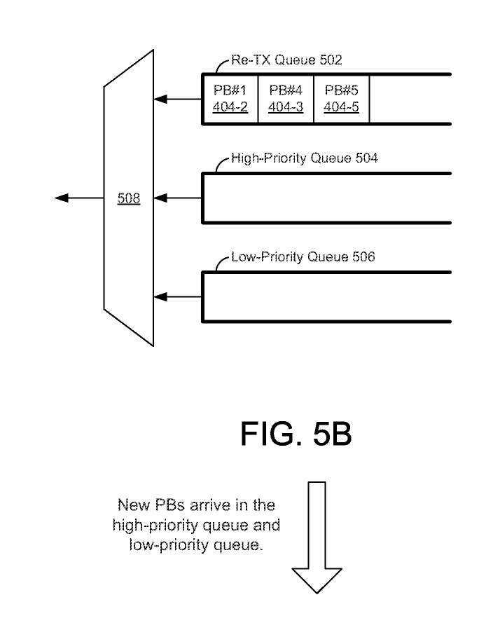

FIG. 4 is a block diagram illustrating an MPDU 400 in accordance with some embodiments. The MPDU 400 includes start frame control information 402 and PBs 404-0 through 404-n, where n is an integer greater than or equal to zero and may vary for different MPDUs 400. The PBs 404-1 may include a mixture of PBs from the high-priority queue 310 or 328, low-priority queue 308 or 326, and/or retransmission queue 312 or 330 (FIG. 3). To transmit the MPDU 400, the transmitter 318 or 336 (FIG. 3) modulates the PBs 404-0 through 404-n into symbols and transmits the symbols. In the receive direction, the receiver 320 or 338 (FIG. 3) receives the symbols and demodulates them into the PBs 404-0 through 404-n. Assuming the PBs 404-0 through 404-n are received correctly, the TDMA MAC 306 or 324 uses the data in the PBs 404-0 through 404-n to generate one or more variable-length frames (e.g., Ethernet frames). A respective PB 404 may be modulated into one symbol, a portion of a symbol, or multiple symbols.

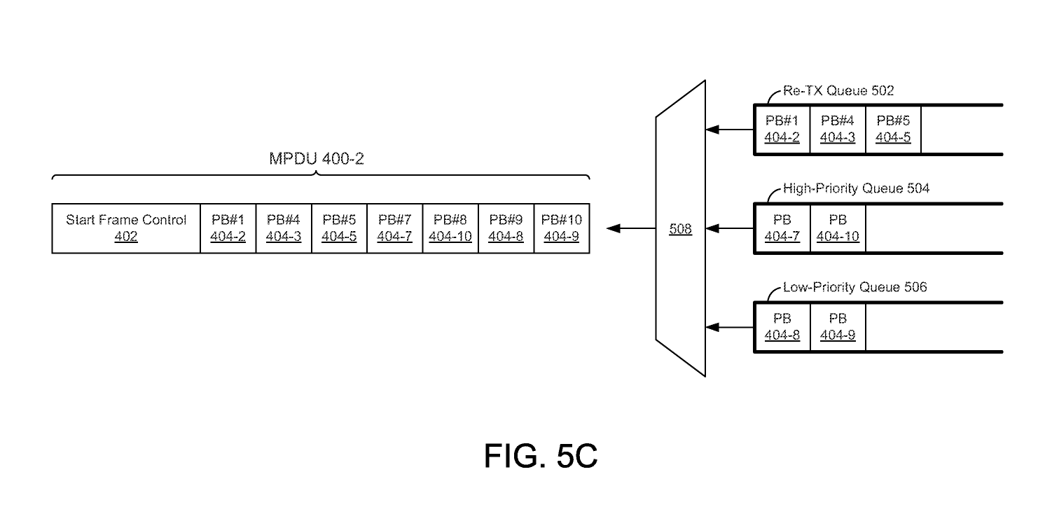

FIGS. 5A-5C illustrate MPDU generation in accordance with some embodiments. In FIGS. 5A-5C, a retransmission queue 502 is an example of retransmission queue 312 or 330 (FIG. 3), a high-priority queue 504 is an example of a high-priority queue 310 or 328 (FIG. 3), and a low-priority queue 506 is an example of a low-priority queue 308 or 326 (FIG. 3). A selector 508 (e.g., as implemented in the TDMA MAC 306 or 324, FIG. 3) arranges PBs 404 from the queues 502, 504, and/or 506 in a sequence and splices the PBs 404 into an MPDU 400.

In FIG. 5A, the retransmission queue 502 is empty; the high-priority queue 504 stores three PBs 404-1, 404-2, and 404-4; and the low-priority queue 506 stores four PBs 404-0, 404-3, 404-5, and 404-6. Some of the PBs in the low-priority queue 506 may have arrived before some of the PBs in the high-priority queue 504. For example, PB 404-0 arrives before PBs 404-1, 404-2, and 404-4. Regardless, the selector 508 arranges the PBs 404-1 through 404-6 in a sequence in an MPDU 400-1 such that the PBs 404-1, 404-2, and 404-4 from the high-priority queue 504 precede the PBs 404-0, 404-3, 404-5, and 404-6 from the low-priority queue 506. The PBs are assigned index numbers based on their order in the sequence. For example, the PBs 404-1, 404-2, and 404-4 from the high-priority queue 504 are assigned index numbers 0 through 2 and the PBs 404-0, 404-3, 404-5, and 404-6 from the low-priority queue 506 are assigned index numbers 3 through 6. This indexing is performed at the time of generation of the MPDU 400-1.

The MPDU 400-1 is transmitted and a selective acknowledgment is received in response. The selective acknowledgment identifies PBs #0, 2, 3, and 6 (i.e., PBs 404-1, -4, -0, and 6) as having been correctly received and PBs #1, 4, and 5 (i.e., PBs 404-2, -3, and -5) as having been received incorrectly. In response, the PBs #1, 4, and 5 (i.e., PBs 404-2, -3, and -5) are stored in the retransmission queue 502, as shown in FIG. 5B.

Additional PBs 404 arrive in the queues 504 and 506. (In some embodiments, additional PBs 404 may arrive in the queues 504 and/or 506 prior to storing the PBs #1, 4, and 5 in the retransmission queue 502, for example if the acknowledgment is a delayed acknowledgment.) In the example of FIG. 5C, additional PBs 404-7 and 404-10 arrive in the high-priority queue 504 and additional PBs 404-8 and 404-9 arrive in the low-priority queue 506. A new MPDU 400-2 is generated: the selector 508 arranges the queued PBs in a sequence, with the PBs #1, 4, and 5 (i.e., PBs 404-2, -3, and -5) from the retransmission queue 502 placed before the PBs 404-7 and 404-10 from the high-priority queue 504, which are placed before the PBs 404-8 and 404-9 from the low-priority queue 506. The PBs 404-7 and 404-10 from the high-priority queue 504 and PBs 404-8 and 404-9 from the low-priority queue 506 are assigned index numbers based on their order in the sequence, starting with the lowest free index number: the PBs 404-7 and 404-10 are assigned index numbers 7 and 8, and the PBs 404-8 and 404-9 are assigned index numbers 9 and 10. This indexing is performed at the time of generation of the MPDU 400-2. The PBs 404-2, -3, and -5 (i.e., PBs #1, 4, and 5) were previously indexed during generation of the MPDU 400-1 (FIG. 5A) and are not re-indexed; they retain their earlier index numbers. The MPDU 400-2 is transmitted.

In some embodiments, the ability of the master device 302 (FIG. 3) to combine data blocks of multiple priorities into a single data unit may be activated or deactivated by the system operator (e.g., the cable operator). In some embodiments, the ability of the slave device 322 (FIG. 3) to combine data blocks of multiple priorities into a single data unit may be activated or deactivated in response to instructions received from the master device 302.

In some embodiments, an acknowledgment is transmitted upon receipt of an MPDU 400 (FIG. 4), during the same time slot in which the MPDU 400 is transmitted. Alternatively, an acknowledgment is transmitted in a later time slot (e.g., a time slot assigned to the receiving device). Such an acknowledgment is referred to as a delayed acknowledgment. Furthermore, the acknowledgment may apply to multiple MPDUs 400.

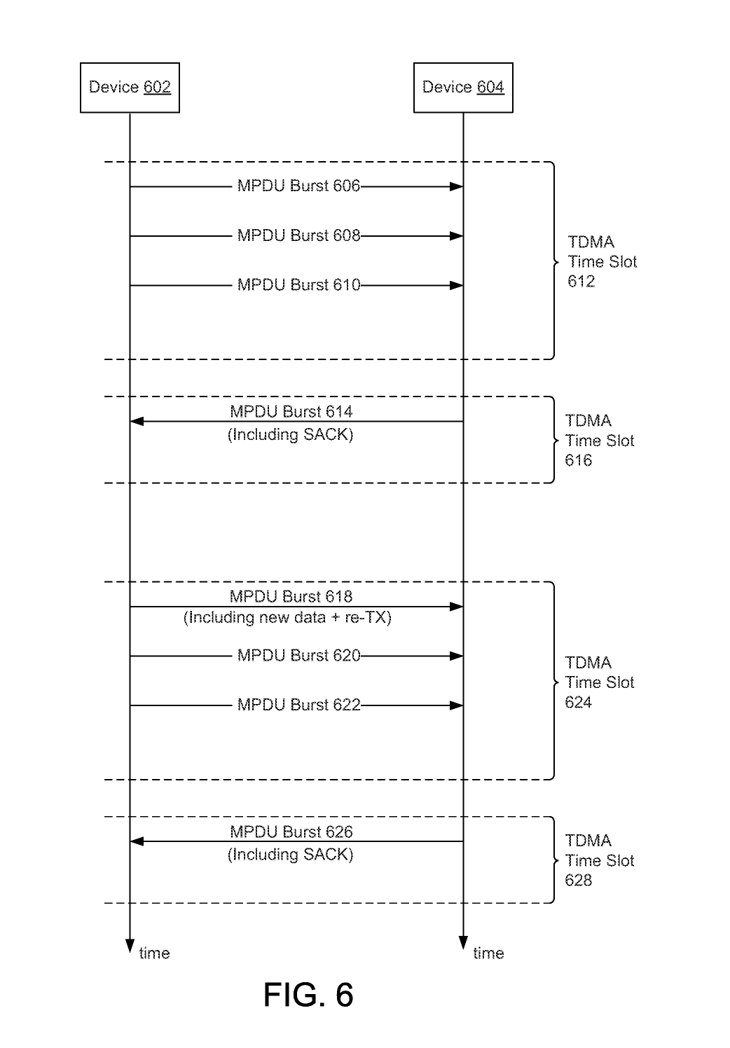

FIG. 6 is a time line illustrating transmission of MPDUs 400 (FIG. 4) and corresponding acknowledgments in accordance with some embodiments. A first networked electronic device 602 transmits MPDUs 400 in respective bursts to a second networked electronic device 604, which responds with delayed acknowledgments that apply to multiple MPDU bursts. In some embodiments, the first device 602 is the master device 302 and the second device 604 is the slave device 322 (FIG. 3). In some other embodiments, the first device 602 is the slave device 322 and the second device 604 is the master device 302 (FIG. 3).

The first device 602 transmits three successive MPDUs 400 in bursts 606, 608, and 610 during a first TDMA time slot 612. If the first device 602 is the master device 302 (FIG. 3), then the first TDMA time slot 612 is a downstream time slot 210 (FIG. 2B). If the first device 602 is the slave device 322 (FIG. 3), then the first TDMA time slot 612 is an upstream time slot 208 (FIG. 2B) assigned to the slave device 322.

The second device 604 determines which PBs 404 (FIG. 4) in the bursts 606, 608, and 610 were received correctly and which were received incorrectly, based for example on checksums for the PBs 404. The second device 604 transmits an MPDU 400 in a burst 614 to the first device 602 during a second TDMA time slot 616. The burst 614 includes a selective acknowledgment (SACK) indicating which PBs 404 in the bursts 606, 608, and 610 were received correctly and which were received incorrectly. For example, the selective acknowledgment includes a bitmap indicating which PBs 404 were received correctly and which were received incorrectly. The second TDMA time slot 616 comes after the first TDMA time slot 612. If the second device 604 is the slave device 322 (FIG. 3), then the second TDMA time slot 616 is an upstream time slot 208 (FIG. 2B) assigned to the slave device 322. If the second device 604 is the master device 302 (FIG. 3), then the second TDMA time slot 616 is a downstream time slot 210 (FIG. 2B).

The first device 602 subsequently transmits three successive MPDUs 400 in bursts 618, 620, and 622 during a third TDMA time slot 624, which comes after the second TDMA time slot 616. The MPDU 400 transmitted in the burst 618 includes PBs 404 being retransmitted in response to the select acknowledgment received in the burst 614, as well as new PBs 404. If the first device 602 is the master device 302 (FIG. 3), then the third TDMA time slot 624 is a downstream time slot 210 (FIG. 2B). If the first device 602 is the slave device 322 (FIG. 3), then the third TDMA time slot 624 is an upstream time slot 208 (FIG. 2B) assigned to the slave device 322.

The second device 604 determines which PBs 404 in the bursts 618, 620, and 622 were received correctly and which were received incorrectly, based for example on checksums for the PBs 404. The second device 604 transmits an MPDU in a burst 626 to the first device 602 during a fourth TDMA time slot 628, which comes after the third TDMA time slot 624. The burst 626 includes a selective acknowledgment (SACK) indicating which PBs in the bursts 618, 620, and 622 were received correctly and which were received incorrectly. If the second device 604 is the slave device 322 (FIG. 3), then the fourth TDMA time slot 628 is an upstream time slot 208 (FIG. 2B) assigned to the slave device 322. If the second device 604 is the master device 302 (FIG. 3), then the fourth TDMA time slot 628 is a downstream time slot 210 (FIG. 2B). Transmissions between the devices 602 and 604 subsequently continue in the manner described.

The acknowledgments in the bursts 614 and 626 thus may be delayed selective acknowledgments. Alternatively, the acknowledgments in the bursts 614 and 626 may be delayed negative acknowledgments. In some embodiments, a negative acknowledgment specifies one of three possibilities, by reporting (i) that all PBs in a burst or group of bursts were received correctly, (ii) the identity of the first and only PB that was not received correctly, or (iii) the identity of the first PB that was not received correctly, with the assumption that all subsequent PBs also were not received correctly. In the second and third cases, the device 602 stores the PB or PBs reported as not being received correctly (including all of the subsequent PBs in the third case) in a retransmission queue 502 (FIGS. 5A-5C) for retransmission.

The acknowledgment mechanism of FIG. 6 may be used for MPDUs that include PBs of a single priority as well as MPDUs that include PBs of multiple priorities.

By implementing retransmission, the acknowledgment mechanism of FIG. 6 provides greater robustness and reliability than for systems that do not include retransmission. Because the acknowledgment is provided in a separate time slot, overhead is reduced and transmission efficiency and throughput increased in the original time slot in which the MPDU(s) corresponding to the acknowledgment were transmitted. Both delayed selective acknowledgments and delayed negative acknowledgments provide this reduction in overhead. Delayed selective acknowledgments provide more flexibility for dealing with errors than delayed negative acknowledgments but consume more processing resources than delayed negative acknowledgments.

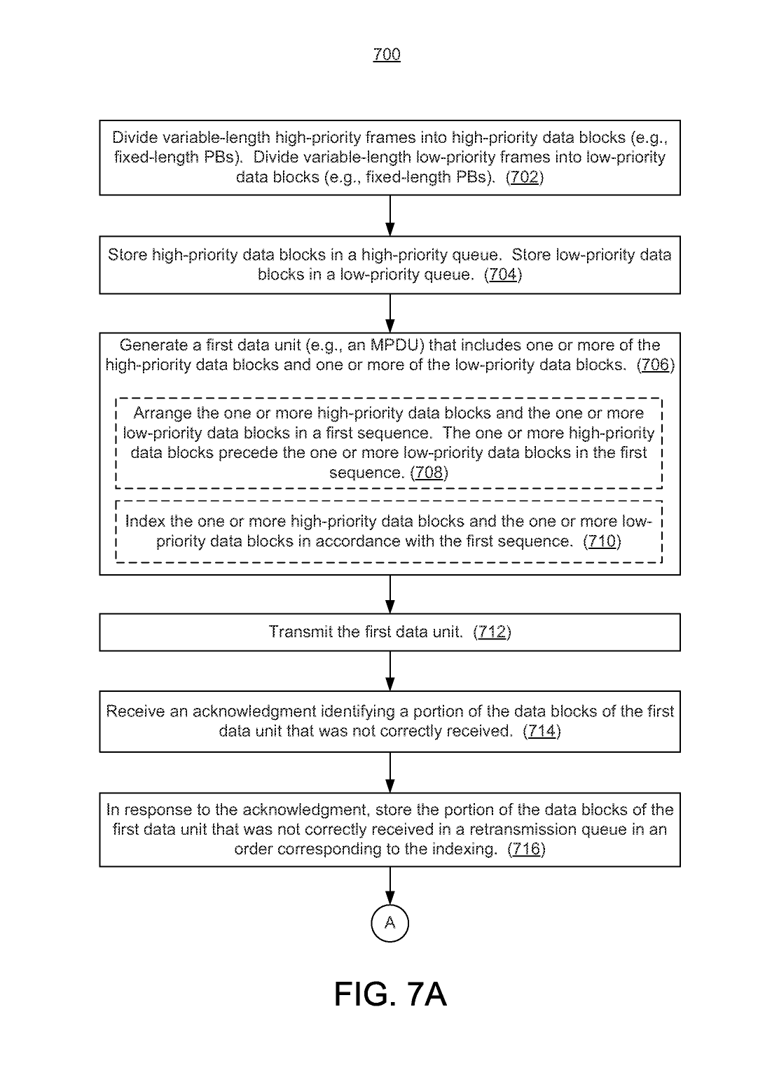

FIGS. 7A and 7B are flow charts illustrating a method 700 of transmitting data in accordance with some embodiments. In some embodiments, the method 700 is performed by the master device 302 (FIG. 3). In some other embodiments, the method 700 is performed by a slave device 322 (FIG. 3).

In the method 700, variable-length high-priority frames (e.g., Ethernet frames) are divided (702) into high-priority data blocks (e.g., fixed-length PBs 404, FIG. 4) and variable-length low-priority frames (e.g., Ethernet frames) are divided (702) into low-priority data blocks (e.g., fixed-length PBs 404, FIG. 4).

The high-priority data blocks are stored (704) in a high-priority queue (e.g., queue 310 or 328, FIG. 3) (e.g., queue 504, FIGS. 5A-5C). The low-priority data blocks are stored (704) in a low-priority queue (e.g., queue 308 or 326, FIG. 3) (e.g., queue 506, FIGS. 5A-5C).

A first data unit is generated (706) that includes one or more of the high-priority data blocks and one or more of the low-priority data blocks. In some embodiments, the first data unit is an MPDU 400 (FIG. 4) (e.g., MPDU 400-1, FIG. 5A) and the data blocks are PBs 404 (FIG. 4). The one or more high-priority data blocks and the one or more low-priority data blocks are arranged (708) in a first sequence, with the one or more high-priority data blocks preceding the one or more low-priority data blocks in the first sequence. The one or more high-priority data blocks and the one or more low-priority data blocks are indexed (710) in accordance with the first sequence (e.g., as illustrated in FIG. 5A).

In some embodiments, one or more previously transmitted data blocks are stored in a retransmission queue (e.g., queue 312 or 330, FIG. 3) (e.g., queue 502, FIGS. 5A-5C). The one or more previously transmitted data blocks were included in an earlier data unit generated and transmitted before the first data unit and are indexed in accordance with their positions in the earlier data unit. The one or more previously transmitted data blocks are included in the first data unit and are placed before the one or more high-priority data blocks in the first sequence, such that they are arranged in the first data unit based on their indexing.

For example, the one or more previously transmitted data blocks are indexed with index numbers corresponding to their positions in the earlier data unit, and the one or more high-priority data blocks and the one or more low-priority data blocks are indexed with index numbers corresponding to their positions in the first sequence. The index numbers of the one or more previously transmitted data blocks precede the index numbers of the one or more high-priority data blocks, and the index numbers of the one or more high-priority data blocks precede the index numbers of the one or more low-priority data blocks.

The first data unit is transmitted (712). For example, the transmitter 318 or 336 (FIG. 3) modulates the first data unit into one or more symbols and transmits the one or more symbols in a burst (e.g., burst 606, 608, or 610, FIG. 6).

An acknowledgment is received (714) identifying a portion of the data blocks of the first data unit that was not correctly received. For example, a selective acknowledgment is received in burst 614 (FIG. 6); the selective acknowledgment includes a bitmap identifying which data blocks of the first data unit were correctly received and which data blocks of the first data unit were not correctly received. In some embodiments, the acknowledgment identifies data blocks that were not correctly received for a plurality of data units (e.g., as transmitted in bursts 606, 608, and 610, FIG. 6) including the first data unit.

In response to the acknowledgment, the portion of the data blocks of the first data unit that was not correctly received is stored (716) in a retransmission queue (e.g., queue 312 or 330, FIG. 3) (e.g., queue 502, FIGS. 5A-5C) in an order corresponding to the indexing (e.g., as shown in FIG. 5B).

A second data unit is generated (718, FIG. 7B) (e.g., MPDU 400-2, FIG. 5C) that includes the portion of the data blocks that was not correctly received (e.g., PBs 404-2, -3, and -5, FIG. 5C) and one or more additional high-priority data blocks (e.g., PBs 404-7 and -10, FIG. 5C). The portion of the data blocks that was not correctly received and the one or more additional high-priority data blocks are arranged (720) in a second sequence. The portion of the data blocks that was not correctly received precedes the one or more additional high-priority data blocks in the second sequence. The one or more additional high-priority data blocks are indexed (722) in accordance with their positions in the second sequence (e.g., as illustrated in FIG. 5C).

In some embodiments, the second data unit further includes (724) one or more additional low-priority data blocks (e.g., PBs 404-8 and 404-9, FIG. 5C). The one or more additional low-priority data blocks are placed (724) after the one or more additional high-priority data blocks in the second sequence and indexed in accordance with their positions in the second sequence (e.g., as illustrated in FIG. 5C).

The second data unit is transmitted (726). For example, the transmitter 318 or 336 (FIG. 3) modulates the second data unit into one or more symbols and transmits the one or more symbols in a burst (e.g., burst 618, FIG. 6).

While the method 700 includes a number of operations that appear to occur in a specific order, it should be apparent that the method 700 can include more or fewer operations, which can be executed serially or in parallel. An order of two or more operations may be changed and two or more operations may be combined into a single operation. For example, all of the operations of the method 700 may be performed in an ongoing basis during successive beacon periods 202 (FIGS. 2A-2B).

By allowing data blocks of multiple priorities to be combined into a single data unit, the method 700 increases the potential number of data blocks that can be included in a data unit and thus improves bandwidth utilization and network throughput. The method 700 also reduces latency for low-priority data, by allowing low-priority data blocks to be transmitted in the same data unit, and thus in the same time slot, as high-priority data blocks. By implementing the method 700 in a system using TDMA in accordance with some embodiments, the potentially increased size of data units does not allow a particular device to consume excess bandwidth, because the device only transmits during assigned time slots. The indexing and sequencing of data blocks in the method 700 ensures that high-priority data is transmitted before low-priority data, thereby honoring quality of service (QoS). This indexing and sequencing also prevents out-of-order transmission of PBs, which makes the method 700 transparent to the receiving device. Furthermore, the method 700 is compatible with both immediate and delayed acknowledgment mechanisms.

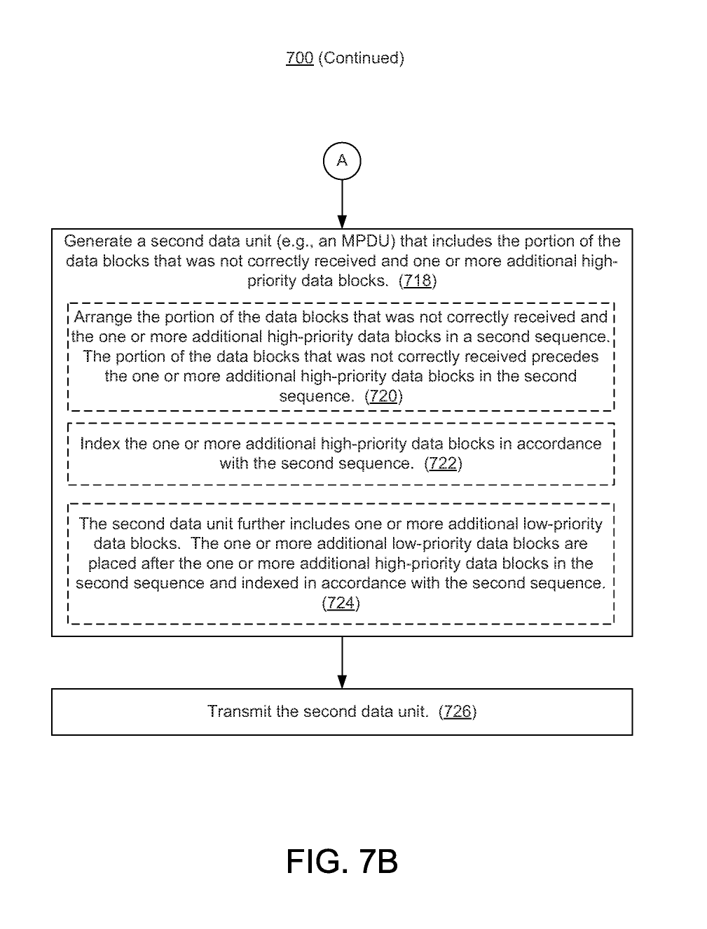

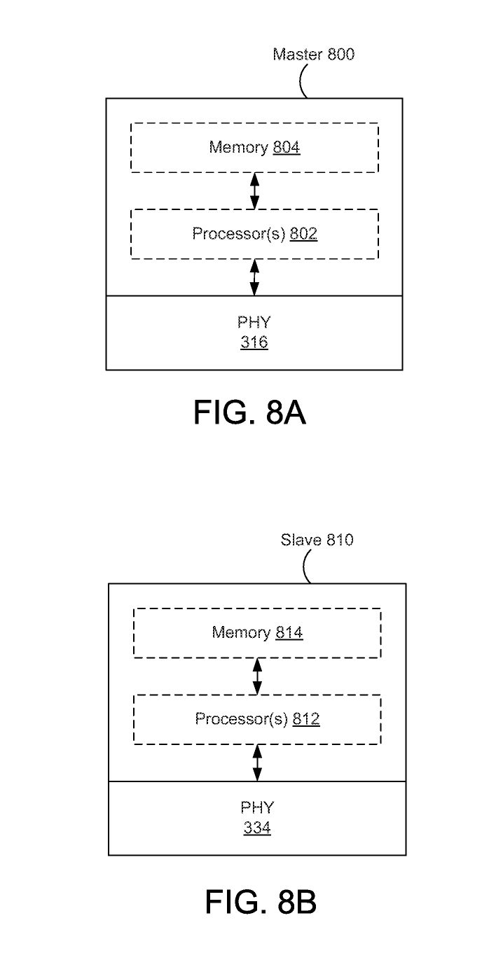

In some embodiments, the TDMA MAC 306 and/or scheduler 304 (FIG. 3) in a master device 302 (FIG. 3) are implemented in software. FIG. 8A is a block diagram of a master device 800 that is an example of such a master device 302 in accordance with some embodiments. In the master device 800, the PHY 316 is coupled to one or more processor cores 802, which are coupled to memory 804. In some embodiments, the memory 804 includes a non-transitory computer-readable medium (e.g., one or more nonvolatile memory elements, such as EPROM, EEPROM, Flash memory, a hard disk drive, and so on) that stores instructions for execution by the one or more processor cores 802. The instructions include instructions that, when executed by the processor core(s) 802, cause the master device 800 to perform all or a portion of the method 700 (FIGS. 7A-7B). For example, the instructions include instructions that, when executed by the processor core(s) 802, cause the master device 800 to generate MPDUs 400 as illustrated in FIGS. 5A-5C.

In some embodiments, the TDMA MAC 324 (FIG. 3) in a slave device 322 (FIG. 3) is implemented in software. FIG. 8B is a block diagram of a slave device 810 that is an example of such a slave device 322 (FIG. 3) in accordance with some embodiments. In the slave device 810, the PHY 334 is coupled to one or more processor cores 812, which are coupled to memory 814. In some embodiments, the memory 814 includes a non-transitory computer-readable medium (e.g., one or more nonvolatile memory elements, such as EPROM, EEPROM, Flash memory, a hard disk drive, and so on) that stores instructions for execution by the one or more processor cores 812. The instructions include instructions that, when executed by the processor core(s) 812, cause the slave device 810 to perform all or a portion of the method 700 (FIGS. 7A-7B). For example, the instructions include instructions that, when executed by the processor core(s) 812, cause the slave device 810 to generate MPDUs 400 as illustrated in FIGS. 5A-5C.

While the memories 804 (FIG. 8A) and 814 (FIG. 8B) are shown as being separate from respective processor core(s) 802 and 812, all or a portion of the memories 804 and/or 814 may be embedded in the respective processor cores 802 and 812. In some embodiments, the processor core(s) 802 and/or 812 are implemented in the same integrated circuit as respective PHYs 316 and 334. For example, the PHYs 316 and/or 334 may be integrated with the respective processor cores(s) 802 and 812 in single chips, which may or may not also include the respective memories 804 and 814.

In the foregoing specification, the present embodiments have been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A method of transmitting data, comprising:
storing high-priority data blocks in a high-priority queue;
storing low-priority data blocks in a low-priority queue;
generating a first data unit comprising one or more of the high-priority data blocks and one or more of the low-priority data blocks, the generating comprising:
arranging the one or more high-priority data blocks and the one or more low-priority data blocks in a first sequence, wherein the one or more high-priority data blocks precede the one or more low-priority data blocks in the first sequence, and
indexing the one or more high-priority data blocks and the one or more low-priority data blocks in accordance with the first sequence; and
transmitting the first data unit.

2. The method of claim 1, wherein:
the method further comprises storing one or more previously transmitted data blocks in a retransmission queue, wherein the one or more previously transmitted data blocks were included in an earlier data unit generated and transmitted before the first data unit; and
generating the first data unit further comprises placing the one or more previously transmitted data blocks before the one or more high-priority data blocks in the first sequence.

3. The method of claim 2, wherein:
the one or more previously transmitted data blocks are indexed in accordance with their positions in the earlier data unit; and
placing the one or more previously transmitted data blocks in the first sequence comprises arranging the one or more previously transmitted data blocks in the first data unit based on their indexing.

4. The method of claim 3, wherein:
the one or more previously transmitted data blocks are indexed with index numbers corresponding to their positions in the earlier data unit;
the one or more high-priority data blocks and the one or more low-priority data blocks are indexed with index numbers corresponding to their positions in the first sequence of the first data unit;
the index numbers of the one or more previously transmitted data blocks precede the index numbers of the one or more high-priority data blocks; and
the index numbers of the one or more high-priority data blocks precede the index numbers of the one or more low-priority data blocks.

5. The method of claim 1, further comprising:
receiving an acknowledgment identifying a portion of the data blocks of the first data unit that was not correctly received; and
in response to the acknowledgment, storing the portion of the data blocks of the first data unit that was not correctly received in a retransmission queue in an order corresponding to the indexing.

6. The method of claim 5, further comprising:
generating a second data unit comprising the portion of the data blocks that was not correctly received and one or more additional high-priority data blocks; and
transmitting the second data unit.

7. The method of claim 6, wherein generating the second data unit comprises:
arranging the portion of the data blocks that was not correctly received and the one or more additional high-priority data blocks in a second sequence, wherein the portion of the data blocks that was not correctly received precede the one or more additional high-priority data blocks in the second sequence; and
indexing the one or more additional high-priority data blocks in accordance with the second sequence.

8. The method of claim 7, wherein:
the second data unit further comprises one or more additional low-priority data blocks; and
generating the second data unit further comprises placing the one or more additional low-priority data blocks in the second sequence after the one or more additional high-priority data blocks and indexing the one or more additional low-priority data blocks in accordance with the second sequence.

9. The method of claim 5, wherein the acknowledgment comprises a bitmap identifying which data blocks of the first data unit were correctly received and which data blocks of the first data unit were not correctly received.

10. The method of claim 5, wherein the acknowledgment identifies data blocks that were not correctly received for a plurality of data units including the first data unit.

11. The method of claim 5, wherein:
the method is performed by a first networked device;
the first data unit is transmitted to a second networked device during a first time slot assigned to the first networked device; and
the acknowledgment is received during a second time slot assigned to the second networked device, wherein the second time slot is subsequent to the first time slot.

12. The method of claim 11, wherein:
the first networked device is a master device;
the second networked device is one of a plurality of slave devices coupled to the master device;
the first time slot is a downstream time slot; and
the second time slot is an upstream time slot assigned by the master device.

13. The method of claim 11, wherein:
the second networked device is a master device;
the first networked device is one of a plurality of slave devices coupled to the master device;
the first time slot is an upstream time slot assigned by the master device; and
the second time slot is a downstream time slot.

14. The method of claim 1, wherein the first data unit comprises a media access control (MAC) protocol data unit (MPDU).

15. The method of claim 1, wherein:
the high-priority data blocks have a fixed length; and
the low-priority data blocks have the fixed length.

16. The method of claim 15, further comprising:
dividing variable-length high-priority frames into the high-priority data blocks; and
dividing variable-length low-priority frames into the low-priority data blocks.

17. The method of claim 1, wherein transmitting the first data unit comprises transmitting one or more symbols corresponding to the first data unit.

18. An electronic device, comprising:
a high-priority queue to store high-priority data blocks;
a low-priority queue to store low-priority data blocks;
a media access controller (MAC) to generate a first data unit comprising one or more of the high-priority data blocks arranged in a sequence with one or more of the low-priority data blocks, wherein:
the one or more high-priority data blocks precede the one or more low-priority data blocks in the sequence, and
the MAC is to index the one or more high-priority data blocks and the one or more low-priority data blocks in accordance with the sequence; and
a transmitter to transmit the first data unit.

19. The electronic device of claim 18, further comprising a retransmission queue to store one or more previously transmitted data blocks that were included in an earlier data unit generated and transmitted before the first data unit;
wherein, to generate the first data unit, the MAC is to place the one or more previously transmitted data blocks before the one or more high-priority data blocks in the sequence.

20. A non-transitory computer-readable storage medium storing one or more programs configured to be executed by an electronic device comprising one or more processors, the one or more programs comprising:
instructions to store high-priority data blocks in a high-priority queue;
instructions to store low-priority data blocks in a low-priority queue;
instructions to generate a first data unit that comprises one or more of the high-priority data blocks and one or more of the low-priority data blocks, the instructions to generate the first data unit comprising:
instructions to arrange the one or more high-priority data blocks and the one or more low-priority data blocks in a sequence, wherein the one or more high-priority data blocks precede the one or more low-priority data blocks in the sequence, and
instructions to index the one or more high-priority data blocks and the one or more low-priority data blocks in accordance with the sequence.

21. The computer-readable storage medium of claim 20, wherein:
the one or more programs further comprise instructions to store one or more previously transmitted data blocks in a retransmission queue, wherein the one or more previously transmitted data blocks were included in an earlier data unit generated before the first data unit; and
the instructions to generate the first data unit further comprise placing the one or more previously transmitted data blocks before the one or more high-priority data blocks in the sequence.

22. A system comprising a plurality of networked electronic devices including a first electronic device and a second electronic device, wherein:
the first electronic device comprises:
a high-priority queue to store high-priority data blocks;
a low-priority queue to store low-priority data blocks;
a retransmission queue to store previously transmitted data blocks that were not correctly received by the second electronic device;
a media access controller (MAC) to generate a first data unit comprising a sequence of the previously transmitted data blocks, one or more of the high-priority data blocks, and one or more of the low-priority data blocks, wherein the previously transmitted data blocks precede the one or more high-priority data blocks in the sequence and the one or more high-priority data blocks precede the one or more low-priority data blocks in the sequence, and wherein the MAC is to index the one or more high-priority data blocks and the one or more low-priority data blocks in accordance with the sequence; and
a transmitter to transmit the first data unit; and
the second electronic device comprises:
a receiver to receive the first data unit; and
a transmitter to transmit an acknowledgment identifying which data blocks of the first data unit were not correctly received.
